(19) United States
(12) Patent Application Publication
(10) Pub. No.: US 2009/0058862 A1
(43) Pub. Date: Mar. 5, 2009

(54) AUTOMATIC AVATAR TRANSFORMATION FOR A VIRTUAL UNIVERSE

(76) Inventors: Peter G. Finn, Brampton (CA); Rick A. Hamilton, II, Charlottesville, VA (US); Clifford A. Pickover, Yorktown Heights, NY (US); James W. Seaman, Falls Church, VA (US)

Correspondence Address: HOFFMAN WARNICK LLC, 75 STATE ST, 14TH FLOOR, ALBANY, NY, 12207, US

(21) Appl. No.: 11/845,178

(22) Filed: Aug. 27, 2007

(51) Int. Cl. G06T 15/70

(52) U.S. Cl. 345/473

(57) ABSTRACT

An approach that automatically transforms an avatar characteristic of an avatar that is online in a virtual universe is described. In one embodiment, there is an avatar locator component configured to locate an avatar that is online in the virtual universe. An avatar characteristics transforming component is configured to automatically transform the avatar characteristic associated with the located avatar according to predetermined transformation criteria.

### BACKGROUND

This disclosure relates generally to virtual universes, and more specifically to automatically transforming characteristics of avatars that exist in these virtual universes.

Virtual universes or virtual worlds are computer-based simulated environments intended for its users to inhabit and interact via avatars, which are personas or representations of the users of the virtual universes and generally take the form of two-dimensional or three-dimensional human or fantastical representations of a person's self. These types of virtual universes are now most common in massive multiplayer online games, such as Second Life which is a trademark of Linden Lab in the United States, other countries or both. Avatars in these types of virtual universes, which can number well over a million, have a wide range of business and social experiences.

The characteristics of an avatar play an important role in these business and social experiences. For example, if the attire of an avatar of a resident of one of these virtual universes typically comprises a bunny outfit, then in some situations such as a business meeting, a wedding, a night at the opera, etc., then this outfit would not be appropriate clothing to wear for such occasions. In such situations, the avatar has an inventory of items that are in their possession and that would likely include clothing outfits. The resident could then manually change the avatar's clothing by using a software functionality (e.g., a control panel) provided with the virtual universe that allows the avatar to remove the bunny outfit and replace it with more formal clothing such as a navy blue or grey suit, if the avatar for instance was attending a business meeting. In addition to visual characteristics such as appearance, other characteristics that play an important role in business and social experiences of an avatar include their voice and motion attributes. As with appearance characteristics, if an avatar wants to change their language, movements, posture or gestures, then the resident needs to manually change these characteristics of the avatar through the software provided via the virtual universe. It is desirable to have other approaches that allow a resident to change the characteristics of their avatar without having to make a manual change.

### SUMMARY

In one embodiment, there is a method for automatically transforming an avatar characteristic of an avatar that is online in a virtual universe. In this embodiment, the method comprises: locating the avatar in the virtual universe; and automatically transforming the avatar characteristic associated with the avatar according to predetermined transformation criteria.

In a second embodiment, there is a method for automatically transforming an avatar characteristic of an avatar located in a region of a virtual universe. In this embodiment, the method comprises: assessing the avatar characteristics associated with the region that the avatar is located; assessing the characteristics of avatars that are located within the general vicinity of the avatar; automatically transforming the avatar characteristic associated with the avatar according to the assessed avatar characteristics associated with the region and the assessed characteristics of avatars that are located within the general vicinity of the avatar.

In a third embodiment, there is an automatic transforming avatar characteristics tool for use in a virtual universe. In this embodiment, the tool comprises an avatar locator component configured to locate an avatar that is online in the virtual universe. An avatar characteristics transforming component is configured to automatically transform an avatar characteristic associated with the located avatar according to predetermined transformation criteria.

In a fourth embodiment, there is a computer-readable medium storing computer instructions, which when executed, enables a computer system to automatically transform an avatar characteristic of an avatar that is online in a virtual universe. In this embodiment, the computer instructions comprises locating the avatar in the virtual universe; and automatically transforming the avatar characteristic associated with the avatar according to predetermined transformation criteria.

In a fifth embodiment, there is a method for deploying an avatar characteristics transformation tool for use in a computer system that automatically transform an avatar characteristic of an avatar that is online in a virtual universe. In this embodiment, a computer infrastructure is provided and is operable to locate the avatar in the virtual universe; and automatically transform the avatar characteristic associated with the avatar according to predetermined transformation criteria.

### BRIEF DESCRIPTION OF THE DRAWINGS

FIG. 1 shows a high-level schematic diagram showing a networking environment for providing a virtual universe according to one embodiment of this disclosure;

FIG. 2 shows a more detailed view of a virtual region shown in the virtual universe of FIG. 1;

FIG. 3 shows a more detailed view of the virtual universe client shown in FIG. 1;

FIG. 4 shows a more detailed view of some the functionalities provided by the server array shown in FIG. 1;

FIG. 5 shows an avatar characteristics transformation tool according to one embodiment of this disclosure that operates in the environment shown in FIG. 1; and

FIG. 6 shows a schematic of an exemplary computing environment in which elements of the networking environment shown in FIG. 1 may operate.

### DETAILED DESCRIPTION

Embodiments of this disclosure are directed to a technique for automatically transforming avatar characteristics of avatars that are online in a virtual universe without necessarily requiring manual changes by the avatar's resident. The embodiments of this disclosure can automatically transform avatar characteristics such as visual, voice or motion attributes so that the avatar's resident does not have to contemplate what changes he or she would like to make. Examples of these types of attributes include appearance, language, dialect, speed of speech, posture, gesture, etc.

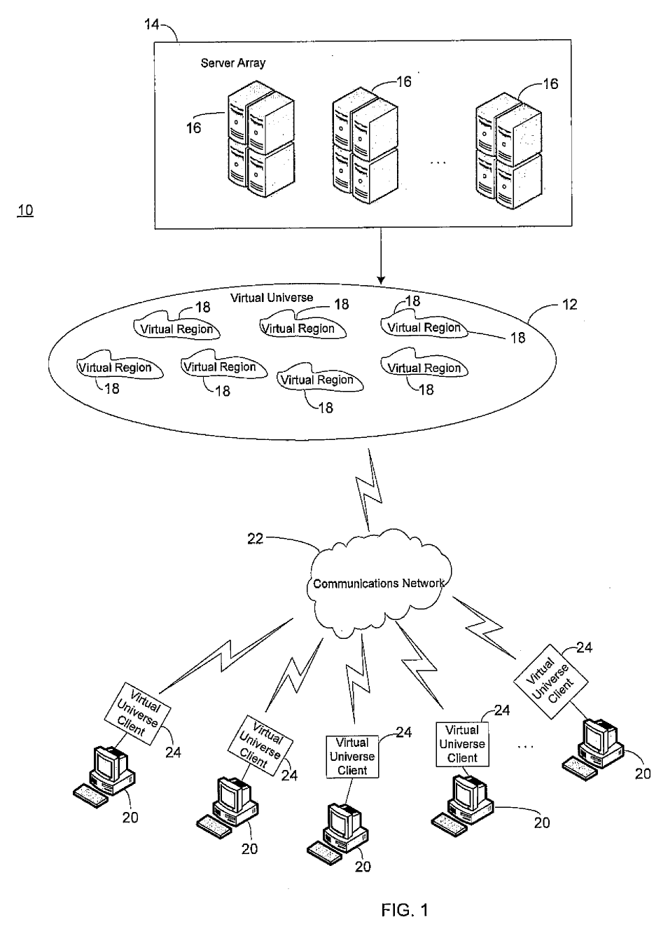

FIG. 1 shows a high-level schematic diagram showing a networking environment 10 for providing a virtual universe 12 according to one embodiment of this disclosure in which a service for automatically transforming avatar characteristics can be utilized. As shown in FIG. 1, the networking environment 10 comprises a server array or grid 14 comprising a plurality of servers 16 each responsible for managing a portion of virtual real estate within the virtual universe 12. A virtual universe provided by a typical massive multiplayer online game can employ thousands of servers to manage all of the virtual real estate. The content of the virtual real estate that is managed by each of the servers 16 within the server array 14 shows up in the virtual universe 12 as a virtual region 18. Like the real-world, each virtual region 18 within the virtual universe 12 comprises a living landscape having things such as buildings, stores, clubs, sporting arenas, parks, beaches, cities and towns all created by residents of the universe that are represented by avatars. These examples of items are only illustrative of some things that may be found in a virtual region and are not limiting. Furthermore, the number of virtual regions 18 shown in FIG. 1 is only for illustration purposes and those skilled in the art will recognize that there may be many more regions found in a typical virtual universe. FIG. 1 also shows that users operating computers 20 interact with the virtual universe 12 through a communication network 22 via a virtual universe client 24 that resides in the computer. Below are further details of the virtual universe 12, server array 14, and virtual universe client 24.

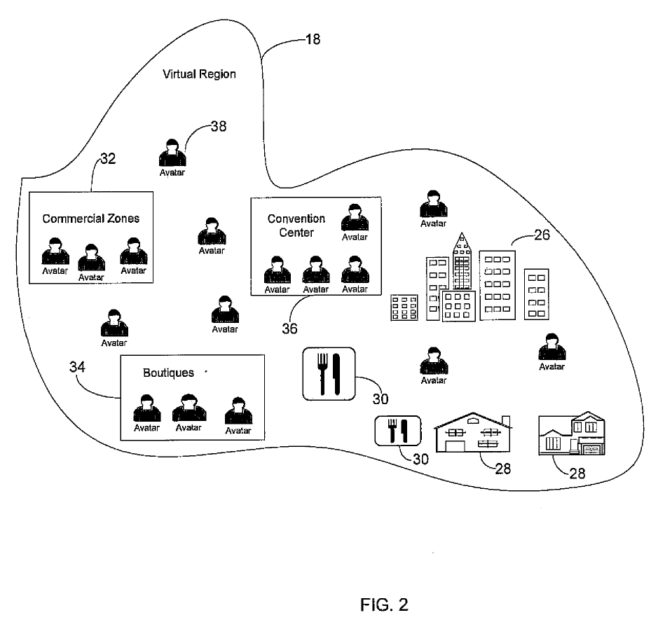

FIG. 2 shows a more detailed view of what one virtual region 18 shown in the virtual universe 12 of FIG. 1 may comprise. As an example, the virtual region 18 shown in FIG. 2 comprises a downtown office center 26, homes 28, restaurants 30 commercial zones 32 and boutiques 34 for shopping and a convention center 36 for meetings and various conventions. Residents or avatars 38, which as mentioned above, are personas or representations of the users of the virtual universe, roam all about the virtual region by walking, driving, flying or even by teleportation or transportation which is essentially moving through space from one point to another, more or less instantaneously. These examples of items in the virtual region 18 shown in FIG. 2 are only illustrative of some things that may be found in a virtual region and those skilled in the art will recognize that these regions can have many more items that can be found in a real-life universe as well as things that do not presently exist in real life.

It is possible that each of these “islands” or areas of the virtual region 18 may have certain appearance requirements to enter or remain. For example, restaurant 30 may be a five-star restaurant that has a formal dress requirement. In one embodiment, formal dress requirement could be specified by the owner of the five-star restaurant or it could be ascertained from a textual description that is typically used to describe a particular island. Other examples of appearance requirements might include having boutiques 34 with a casual dress requirement. Therefore, an avatar that is leaving the five-star restaurant or getting off work from their job as an investment banker in an office in downtown 26 may want to change from their formal suit to a more casual outfit such as a muumuu.

Still other scenarios in which avatar characteristics might come into play could arise in a commercial zone 32 if for example this zone was the “Chinatown” of virtual region 18. If the commercial zone 32 was indeed a Chinatown, then it is likely that a majority of the avatars could be communicating in Mandarin or Cantonese and using gestures (e.g., bowing) or movements (e.g., Tai Chi, Qi Qong) that one would expect to find in an area predominated with people with an Asian background.

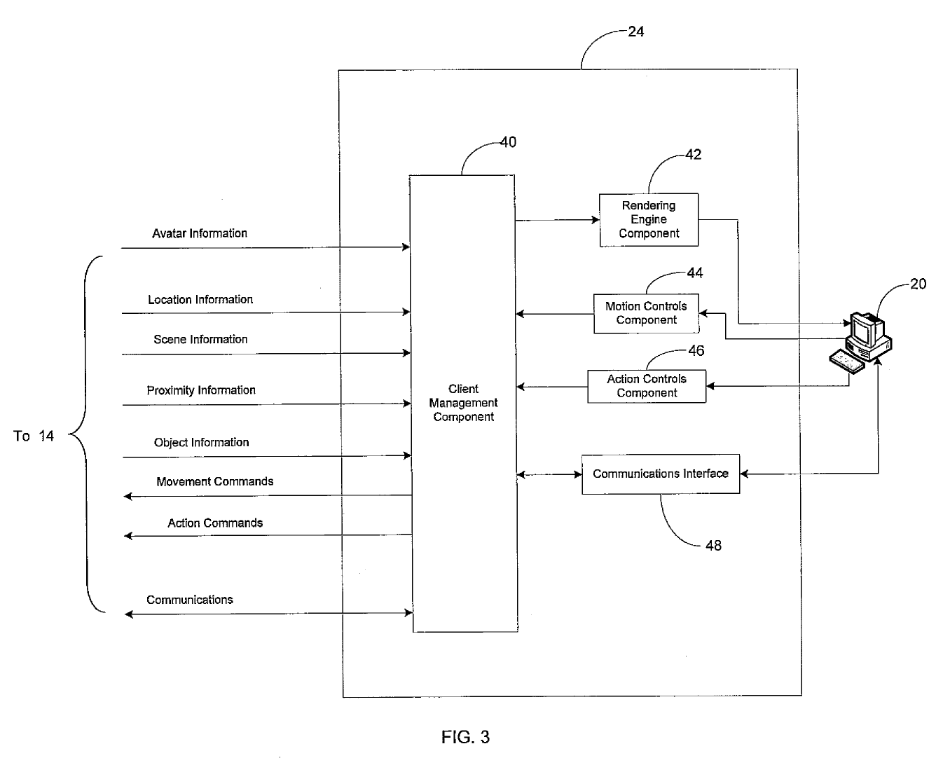

FIG. 3 shows a more detailed view of the virtual universe client 24 shown in FIG. 1. The virtual universe client 24, which enables users to interact with the virtual universe 12, comprises a client management component 40, which manages actions, movements and communications made by a user through computer 20, and information received from the virtual universe through the server array 14. A rendering engine component 42 enables the user of the computer 20 to visualize his or her avatar within the surroundings of the particular region of the virtual universe 12 that it is presently located. A motion controls component 44 enables the user to make movements through the virtual universe. In one embodiment, movements through the virtual universe can include for example, gestures, postures, walking, running, driving, flying, etc. An action controls component 46 enables the user to perform actions in the virtual universe such as buying items for his or her avatar or even for their real-life selves, building homes, planting gardens, etc., as well as changing the appearance of their avatar. These actions are only illustrative of some possible actions that a user can perform in the virtual universe and are not limiting of the many possible actions that can be performed. A communications interface 48 enables a user to communicate with other users of the virtual universe 12 through modalities such as chatting, instant messaging, gesturing, talking and electronic mail (e-mail).

FIG. 3 shows the various types of information received by the client management component 40 from the virtual universe through the server array 14. In particular, the client management component 40 receives avatar information about the avatars that are in proximity to the user's avatar. In addition, the client management component 40 receives location information about the area that the user's avatar is near (e.g., what region or island he or she is in) as well as scene information (e.g., what the avatar sees). The client management component 40 also receives proximity information which contains information on what the user's avatar is near and object information which is information that can be obtained by one's senses (e.g., touch, taste, smell, etc.,) and what actions are possible for nearby objects (e.g., postures, movements, etc.). FIG. 3 also shows the movement commands and action commands that are generated by the user are sent to the server array via the client management component 40, as well as the communications that can be sent to the users of other avatars within the virtual universe.

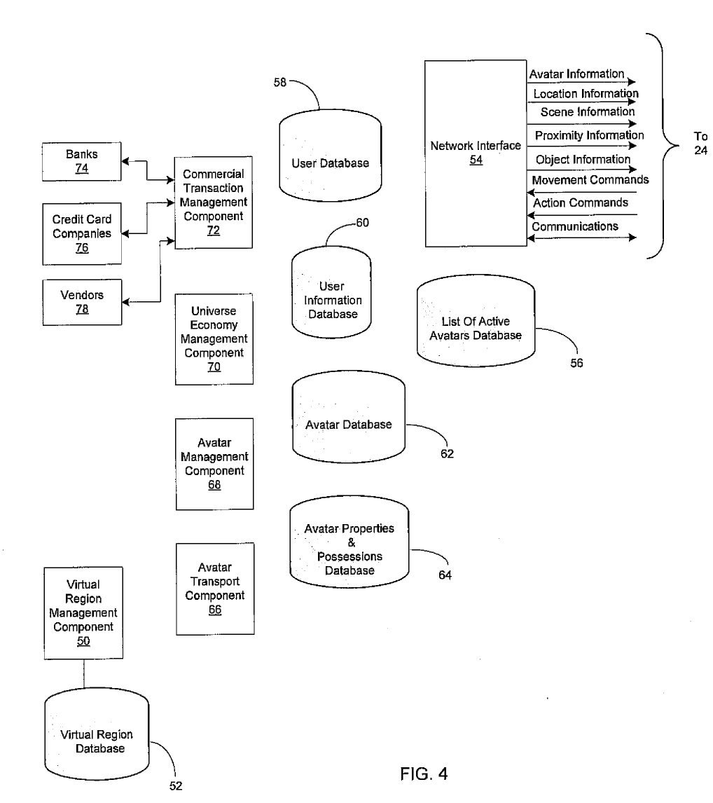

FIG. 4 shows a more detailed view of some the functionalities provided by the server array 14 shown in FIG. 1. In particular, FIG. 4 shows a virtual region management component 50 that manages a virtual region within the virtual universe. In particular, the virtual region management component 50 manages what happens in a particular region such as the type of landscape in that region, the amount of homes, commercial zones, boutiques, streets, parks, restaurants, etc. For example, the virtual region management component 50 would allow the owner of a particular region or establishment within the region to specify requirements for entering or remaining within the region that could potentially affect certain avatar characteristics. In addition, the virtual region management component 50 would allow the owner of a particular region or establishment to provide a textual description that describes the area in more detail so that the avatar can ascertain if there will be a potential effect on their avatar characteristics. Those skilled in the art will recognize that the virtual region management component 50 can manage many other items within the virtual region.

A virtual region database 52 stores information on all of the items in the virtual region 18 that the virtual region management component 50 is managing. In one embodiment, for very large virtual universes, one server 16 may be responsible for managing one particular virtual region 18 within the universe. In other embodiments, it is possible that one server 16 may be responsible for handling one particular island within the virtual region 18.

FIG. 4 shows a network interface 54 that enables the server array 14 to interact with the virtual universe client 24 residing on computer 20. In particular, the network interface 54 communicates avatar, location, scene, proximity and object information to the user through the virtual universe client 24 and receives movement and action commands as well as communications from the user via the universe client.

As shown in FIG. 4, there are several different databases for storing information. In particular, database 56 contains a list of all the avatars that are online in the virtual universe 12. Databases 58 and 60 contain information on the actual human users of the virtual universe 12. In one embodiment, database 58 contains general information on the users such as names, addresses, interests, ages, etc., while database 60 contains more private information on the users such as email addresses, billing information (e.g., credit card information) for taking part in transactions. Databases 62 and 64 contain information on the avatars of the users that reside in the virtual universe 12. In one embodiment, database 62 contains information such as all of the avatars that a user may have, the profile of each avatar, avatar characteristics (e.g., appearance, voice and movement features) while database 64 contains an inventory listing properties and possessions that each avatar owns such as houses, cars, sporting equipment, appearance, attire, etc. Those skilled in the art will recognize that databases 58-64 may contain additional information if desired. Although the above information is shown in FIG. 4 as being stored in databases, those skilled in the art will recognize that other means of storing information can be utilized.

An avatar transport component 66 enables users to transport, which as mentioned above, allows avatars to transport through space from one point to another point, instantaneously. As a result, an avatar could for example go from New York City, N.Y. to the Chilean Tierra del Fuego to trek the Dientes Circuit or to leave an Australian Rules Football game to go shopping in a mall in Buenos Aires, Argentina. Moving from one point to another point could ultimately affect the characteristics of the avatar. For example, if the avatar was going from the streets of Niskayuna, N.Y., to the Chilean Tierra del Fuego to trek the Dientes Circuit, then the avatar might want to remove their body armor and put on some hiking gear for a six day trek. Also, the avatar might want to be able to speak Spanish since a majority of the other avatars that he could be meeting will likely be speaking either Spanish or Castilian.

An avatar management component 68 keeps track of what online avatars are doing while in the virtual universe. For example, the avatar management component 68 can track where the avatar presently is in the virtual universe, what activities it is performing or has recently performed. An illustrative but non-exhaustive list of activities can include shopping, eating, talking, recreating, etc.

Because a typical virtual universe has a vibrant economy, the server array 14 has functionalities that are configured to manage the economy. In particular, a universe economy management component 70 manages transactions that occur within the virtual universe between avatars. In one embodiment, the virtual universe 12 will have their own currency that users pay for with real-life money. The users can then take part in commercial transactions for their avatars through the universe economy management component 70. For example, an avatar might want to buy a surfboard so that it can go surfing. In this case, the avatar would make the purchase using the virtual universe currency to make the purchase. In some instances, the user may want to take part in a commercial transaction that benefits him or her and not their avatar. In this case, a commercial transaction management component 72 allows the user to participate in the transaction. For example, while walking around a commercial zone, an avatar may see a pair of shoes that he or she would like for themselves and not their avatar. In order to fulfill this type of transaction and others similarly related, the commercial transaction management component 72 interacts with banks 74, credit card companies 76 and vendors 78.

Although not expressly shown in FIG. 4, all of the components shown in the figure are configured to interact with each other. The components that are shown as being interconnected are illustrated in that manner to convey the close interactions that exist between these components such as the banks 74, credit card companies 76, and vendors with the commercial transaction management component 72.

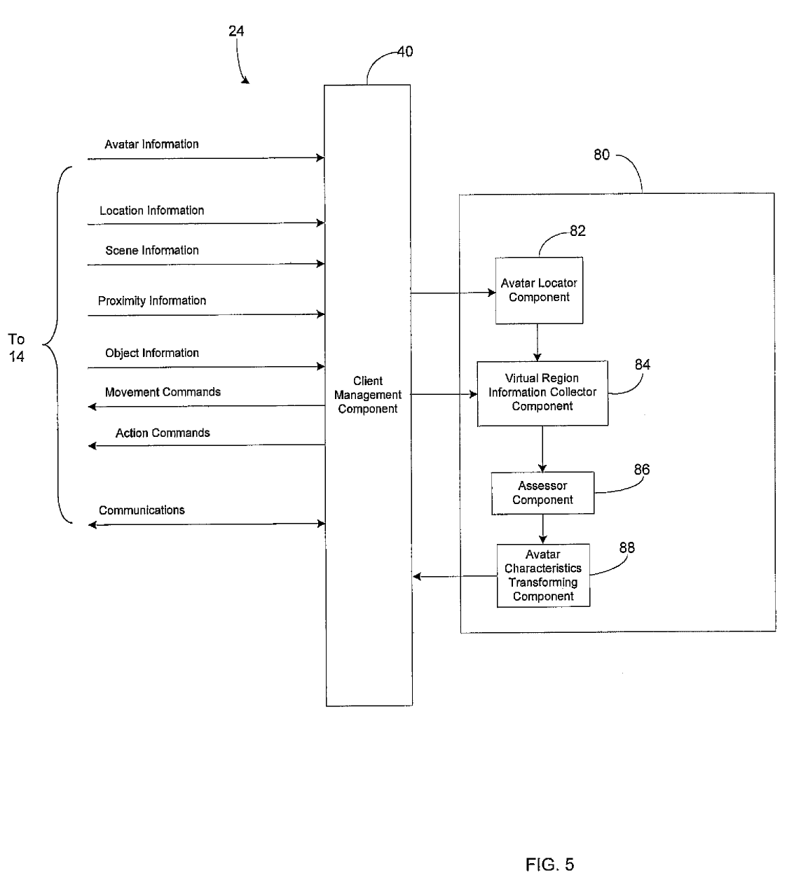

FIG. 5 shows an avatar characteristics transformation tool 80 according to one embodiment of this disclosure that operates in the environment of FIG. 1. In particular, the avatar characteristics transformation tool 80 provides the capability to automatically transform characteristics of an avatar. As shown in FIG. 5, in this embodiment, the avatar characteristics transformation tool 80 resides on the same computer system as the virtual universe client 24 and communicates directly to the virtual universe and its residents via the virtual universe client 24. In other embodiments, the avatar characteristics transformation tool 80 might reside on the same computers as the virtual universe servers 16, or reside on separate computers in direct communication with the virtual universe servers 16.

Referring back to FIG. 5, the avatar characteristics transformation tool 80 comprises an avatar locator component 82 that monitors the location of avatars that are online in the virtual universe. The avatar locator component 82 is also configured to determine what virtual regions are within close proximity to the avatar. As used herein, being in close proximity can mean within a specific predetermined distance of the located avatar, such as within virtual visual distance or within sufficient distance to establish local avatar communications.

A virtual region information collector component 84 collects information that relates to the region that an avatar is in or within close proximity. For example, the virtual region information collector component 84 is configured to collect information such as what business, activities, interactions, etc., occur in a particular virtual region and if there are special requirements that have been specified by the owner of the region for entering or remaining in the region. In addition, the virtual region information collector component 84 is configured to obtain any textual information that describes the business, activities, interactions, etc., that occur in a particular virtual region as provided by the owner or resident in charge of that region or island. In one embodiment, the virtual region information collector component 84 queries the region to obtain any requirements or textual descriptions that are provided in conjunction with the particular region or island.

Other information collected by the virtual region information collector component 84 includes information on the avatars including their characteristics. For example, the virtual region information collector component 84 can collect information on avatars that are in close proximity to an avatar of interest. In one embodiment, the virtual region information collector component 84 can determine what clothing other avatars in the general vicinity are wearing by using flags or tags that indicate certain characteristics. For example, consider visual or appearance characteristics, each outfit that an avatar possesses can be set to a particular flag or tagged with a particular tag. A bit 0 could represent a business outfit; a bit 1 could represent a casual outfit; while a bit 2 could represent a leisure outfit. Other bits could be used to designate special outfits like an animal variant, soldier/warrior attire, etc. The virtual region information collector component 84 could then collect this appearance metadata from the avatar. In another embodiment, the virtual region information collector component 84 can use gather data that pertains to the type of clothing that avatars are wearing from which artificial intelligence processing techniques such as pattern recognition can be used later more detailed information. These above mentioned embodiments could be used to collect information on other characteristics of the avatars in the vicinity such as language spoken, including the dialect, accent, speed of speech as well as movement characteristics including postures and gestures. Furthermore, the virtual region information collector component 84 can collect other characteristics on the avatars such as interests, persona, age, interactions, etc.

Referring back to FIG. 5, the avatar characteristics transformation tool 80 further comprises an assessor component 86 configured to assess the location information and avatar characteristics collected by the virtual region information collector component 84. In particular, the assessor component 86 assesses the avatar characteristics associated with the location in the virtual universe that an avatar is located in and the characteristics of the avatars that are located in the general vicinity of the avatar. In one embodiment, for characteristics associated with the location of the avatar, the assessment will be evident if the owner of the virtual region has specified a dress requirement for entering the region. If there is only a textual description, then the assessor component has to determine from the description whether this will affect the characteristics of the avatar. For example, if the virtual region was a music hall and the description stated that the music hall was used only for operas, orchestras, symphonies, then the assessor component 86 could ascertain that the avatar needs to be dressed in formal clothing attire.

With regard to the use of characteristics of the avatars that are located in the same general vicinity as the avatar of interest, in one embodiment the assessor component 86 can perform a statistical analysis on these avatar characteristics to determine what features may be necessary to be in the same vicinity as these other avatars. For example, if 60% of the avatars that are within a 30 foot radius of the avatar of interest are in bathing suits then the assessor component 86 will ascertain that the avatar should be in bathing suit. This form of statistical analysis can be used to determine other avatar characteristics of similarly located avatars such as voice (i.e., audio) and movement characteristics.

In another embodiment, the assessor component 86 is configured to analyze the metadata associated with the avatars in the general vicinity of the avatar of interest to determine what avatar characteristics may be needed. For example, if a majority of avatars within a 40 foot radius of the avatar of interest are tagged with a bit representative of formal wear, then the assessor component 86 would determine from that metadata that formal wear is the proper attire at this particular region. In another embodiment, the assessor component 86 is configured to use artificial intelligence data processing techniques such as pattern recognition to determine what other avatars in the same vicinity are wearing. If the other avatars are wearing white robes then the assessor component 86 could learn to determine that the avatars are at martial arts gym and that the avatar would need to put on his or her robe.

An avatar characteristics transforming component 88 is configured to automatically transform the characteristics of the avatar if predetermined transformation criteria has been met. In one embodiment, the predetermined transformation criteria comprise location of the avatar in the virtual universe and the characteristics of the avatars that are in the general vicinity of an avatar of interest. In one embodiment, before the avatar characteristics transforming component 88 automatically transforms the avatar characteristics, the component has to determine whether the avatar has granted permission to have an automatic transformation occur. If the avatar has not agreed to permit automatic transformations, then the avatar characteristics transforming component 88 would not transform the characteristics. Typically, this type of information could be stored in the avatar database 62 (FIG. 4) in the profile set up for the avatar. If the avatar has agreed to automatic transformations of characteristics, then the avatar characteristics transforming component 88 could retrieve the certain items from the avatar properties and possession database 64 if for example, a new outfit is being placed on the avatar.

In other embodiments where the avatar has multiple profiles, then it is possible that the avatar characteristics transforming component 88 could automatically transform or morph from one avatar to another one. For example, a resident could have one avatar, Avatar 1, that is a goat in shorts and a tee shirt and another avatar, Avatar 2, that is in human form who normally wears a coat and tie. Therefore, before the avatar enters a business meeting the assessor component 86 could determine that different characteristics were needed and thus notify the avatar characteristics transforming component 88 which would then automatically transform Avatar 1 into Avatar 2 when entering a business meeting. Other embodiments might include transforming an avatar to transform into a specific or random type-specific character. For example, it may be desirable to have all participants in a business meeting appear as humans wearing the same business apparel, perhaps all looking identical or randomly morphing into gender and/or age appropriate representations. Therefore, the avatar characteristics transforming component 88 could make this transformation after it has been ascertained what the necessary characteristic should be for the meeting.

Additional embodiments could include morphing other avatars in the same vicinity to a particular avatar with characteristics such that the avatar would only see these characteristics regardless of their actual current state. For example, an avatar could see all other avatars as zebra-shaped monsters. Likewise, other avatars could have one particular avatar with plain vanilla features, regardless of its actual current state.

In another embodiment of this disclosure, the avatar characteristics transformation tool 80 is used as a service to charge fees for each automatic transformation invoked, the degree of transformation invoked (e.g., changing appearance and voice as opposed to only a movement change) and the kind of transformation. In this embodiment, the provider of the virtual universe or a third party service provider could offer this automatic avatar characteristics transformation as a service by performing the functionalities described herein on a subscription and/or fee basis. In this case, the provider of the virtual universe or the third party service provider can create, deploy, maintain, support, etc., the avatar characteristics transformation tool 80 that performs the processes described in the disclosure. In return, the virtual universe or the third party service provider can receive payment from the virtual universe residents via the universe economy management component 70 and the commercial transaction management component 72.

In still another embodiment, the methodologies disclosed herein can be used within a computer system to automatically transform avatar characteristics of avatars that are online in a virtual universe. In this case, the avatar characteristics transformation tool 80 can be provided and one or more systems for performing the processes described in the disclosure can be obtained and deployed to a computer infrastructure. To this extent, the deployment can comprise one or more of (1) installing program code on a computing device, such as a computer system, from a computer-readable medium; (2) adding one or more computing devices to the infrastructure; and (3) incorporating and/or modifying one or more existing systems of the infrastructure to enable the infrastructure to perform the process actions of the disclosure.

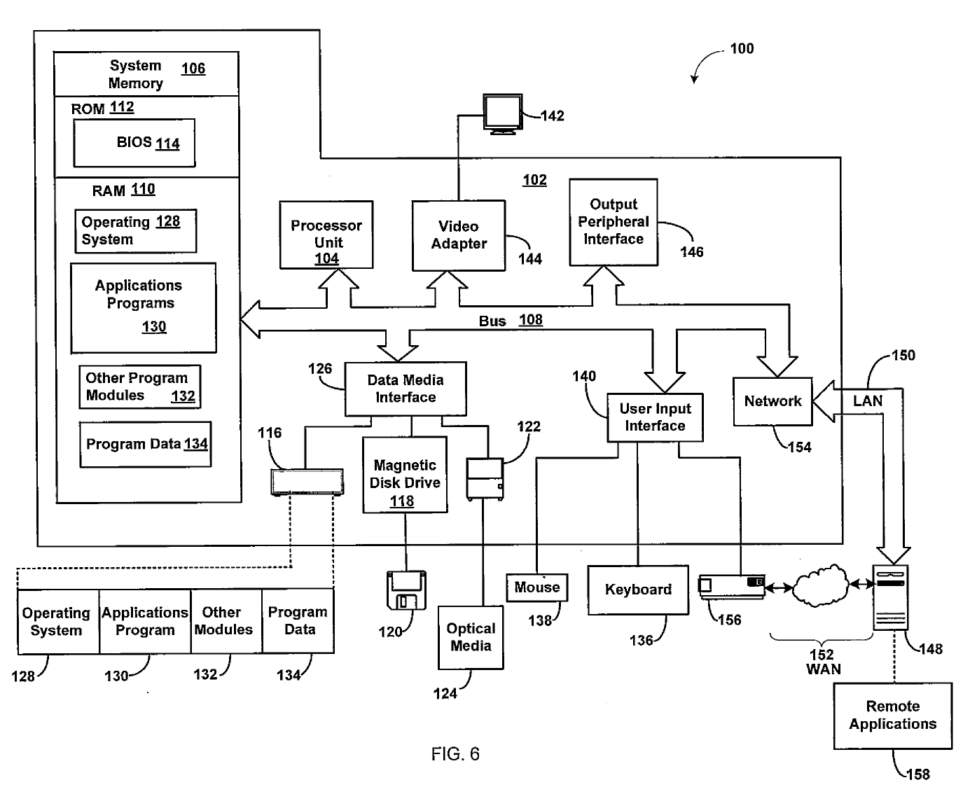

FIG. 6 shows a schematic of an exemplary computing environment in which elements of the networking environment shown in FIG. 1 may operate. The exemplary computing environment 100 is only one example of a suitable computing environment and is not intended to suggest any limitation as to the scope of use or functionality of the approach described herein. Neither should the computing environment 100 be interpreted as having any dependency or requirement relating to any one or combination of components illustrated in FIG. 6.

In the computing environment 100 there is a computer 102 which is operational with numerous other general purpose or special purpose computing system environments or configurations. Examples of well known computing systems, environments, and/or configurations that may be suitable for use with an exemplary computer 102 include, but are not limited to, personal computers, server computers, thin clients, thick clients, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The exemplary computer 102 may be described in the general context of computer-executable instructions, such as program modules, being executed by a computer. Generally, program modules include routines, programs, objects, components, logic, data structures, and so on, that performs particular tasks or implements particular abstract data types. The exemplary computer 102 may be practiced in distributed computing environments where tasks are performed by remote processing devices that are linked through a communications network. In a distributed computing environment, program modules may be located in both local and remote computer storage media including memory storage devices.

As shown in FIG. 6, the computer 102 in the computing environment 100 is shown in the form of a general-purpose computing device. The components of computer 102 may include, but are not limited to, one or more processors or processing units 104, a system memory 106, and a bus 108 that couples various system components including the system memory 106 to the processor 104.

Bus 108 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 102 typically includes a variety of computer readable media. Such media may be any available media that is accessible by computer 102, and it includes both volatile and non-volatile media, removable and non-removable media.

In FIG. 6, the system memory 106 includes computer readable media in the form of volatile memory, such as random access memory (RAM) 110, and/or non-volatile memory, such as ROM 112. A BIOS 114 containing the basic routines that help to transfer information between elements within computer 102, such as during start-up, is stored in ROM 112. RAM 110 typically contains data and/or program modules that are immediately accessible to and/or presently operated on by processor 104.

Computer 102 may further include other removable/non-removable, volatile/non-volatile computer storage media. By way of example only, FIG. 6 illustrates a hard disk drive 116 for reading from and writing to a non-removable, non-volatile magnetic media (not shown and typically called a “hard drive”), a magnetic disk drive 118 for reading from and writing to a removable, non-volatile magnetic disk 120 (e.g., a “floppy disk”), and an optical disk drive 122 for reading from or writing to a removable, non-volatile optical disk 124 such as a CD-ROM, DVD-ROM or other optical media. The hard disk drive 116, magnetic disk drive 118, and optical disk drive 122 are each connected to bus 108 by one or more data media interfaces 126.

The drives and their associated computer-readable media provide nonvolatile storage of computer readable instructions, data structures, program modules, and other data for computer 102. Although the exemplary environment described herein employs a hard disk 116, a removable magnetic disk 118 and a removable optical disk 122, it should be appreciated by those skilled in the art that other types of computer readable media which can store data that is accessible by a computer, such as magnetic cassettes, flash memory cards, digital video disks, RAMs, ROM, and the like, may also be used in the exemplary operating environment.

A number of program modules may be stored on the hard disk 116, magnetic disk 120, optical disk 122, ROM 112, or RAM 110, including, by way of example, and not limitation, an operating system 128, one or more application programs 130, other program modules 132, and program data 134. Each of the operating system 128, one or more application programs 130 other program modules 132, and program data 134 or some combination thereof, may include an implementation of the networking environment 10 of FIG. 1 including the server array 14, the virtual universe client 24 and the avatar characteristics transformation tool 80.

A user may enter commands and information into computer 102 through optional input devices such as a keyboard 136 and a pointing device 138 (such as a “mouse”). Other input devices (not shown) may include a microphone, joystick, game pad, satellite dish, serial port, scanner, camera, or the like. These and other input devices are connected to the processor unit 104 through a user input interface 140 that is coupled to bus 108, but may be connected by other interface and bus structures, such as a parallel port, game port, or a universal serial bus (USB).

An optional monitor 142 or other type of display device is also connected to bus 108 via an interface, such as a video adapter 144. In addition to the monitor, personal computers typically include other peripheral output devices (not shown), such as speakers and printers, which may be connected through output peripheral interface 146.

Computer 102 may operate in a networked environment using logical connections to one or more remote computers, such as a remote server/computer 148. Remote computer 148 may include many or all of the elements and features described herein relative to computer 102.

Logical connections shown in FIG. 6 are a local area network (LAN) 150 and a general wide area network (WAN) 152. Such networking environments are commonplace in offices, enterprise-wide computer networks, intranets, and the Internet. When used in a LAN networking environment, the computer 102 is connected to LAN 150 via network interface or adapter 154. When used in a WAN networking environment, the computer typically includes a modem 156 or other means for establishing communications over the WAN 152. The modem, which may be internal or external, may be connected to the system bus 108 via the user input interface 140 or other appropriate mechanism.

In a networked environment, program modules depicted relative to the personal computer 102, or portions thereof, may be stored in a remote memory storage device. By way of example, and not limitation, FIG. 6 illustrates remote application programs 158 as residing on a memory device of remote computer 148. It will be appreciated that the network connections shown and described are exemplary and other means of establishing a communications link between the computers may be used.

An implementation of an exemplary computer 102 may be stored on or transmitted across some form of computer readable media. Computer readable media can be any available media that can be accessed by a computer. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

It is apparent that there has been provided with this disclosure an approach for automatic avatar transformation for a virtual universe. While the disclosure has been particularly shown and described in conjunction with a preferred embodiment thereof, it will be appreciated that variations and modifications will occur to those skilled in the art. Therefore, it is to be understood that the appended claims are intended to cover all such modifications and changes as fall within the true spirit of the invention.

What is claimed is:

1. A method for automatically transforming an avatar characteristic of an avatar that is online in a virtual universe, comprising:
locating the avatar in the virtual universe; and
automatically transforming the avatar characteristic associated with the avatar according to predetermined transformation criteria.

2. The method according to claim 1, wherein the avatar characteristic comprises at least one of visual, voice or motion attributes.

3. The method according to claim 2, wherein the visual, voice and motion attributes comprise appearance, language, posture and gesture.

4. The method according to claim 1, wherein the predetermined transformation criteria comprises location of the avatar in the virtual universe and characteristics of avatars that are in the general vicinity of the located avatar.

5. The method according to claim 1, further comprising assessing avatar characteristics associated with the location in the virtual universe that the avatar is located in.

6. The method according to claim 5, wherein the assessing of avatar characteristics comprises querying the location in the virtual universe that the avatar is located for specified avatar characteristics for remaining in the location.

7. The method according to claim 5, wherein the assessing of avatar characteristics comprises ascertaining a textual description associated with the location in the virtual universe and determining avatar characteristics from the textual description.

8. The method according to claim 1, further comprising assessing characteristics of avatars that are in the general vicinity of the located avatar.

9. The method according to claim 8, wherein the assessing of avatar characteristics comprises performing a statistical analysis on the avatar characteristics associated with the avatars that are in the general vicinity of the located avatar.

10. The method according to claim 8, wherein the assessing of avatar characteristics comprises analyzing metadata associated with the avatars and determining avatar characteristics of the avatars located in the general vicinity of the located avatar.

11. The method according to claim 8, wherein the assessing of avatar characteristics comprises using artificial intelligence data processing techniques to determine avatar characteristics of the avatars located in the general vicinity of the located avatar.

12. The method according to claim 1, further comprising charging a transformation fee to the avatar for the automatic transformation of an avatar characteristic.

13. The method according to claim 12, wherein the transformation fee is based on the kind of transformation performed.

14. The method according to claim 1, further comprising determining whether the avatar has granted permission for the automatic transformation of avatar characteristics.

15. A method for automatically transforming an avatar characteristic of an avatar located in a region of a virtual universe, comprising:
assessing the avatar characteristics associated with the region that the avatar is located;
assessing the characteristics of avatars that are located within the general vicinity of the avatar;
automatically transforming an avatar characteristic associated with the avatar according to the assessed avatar characteristics associated with the region and the assessed characteristics of avatars that are located within the general vicinity of the avatar.

16. An automatic transforming avatar characteristics tool for use in a virtual universe, comprising:
an avatar locator component configured to locate an avatar that is online in the virtual universe; and
an avatar characteristics transforming component configured to automatically transform an avatar characteristic associated with the located avatar according to predetermined transformation criteria.

17. The automatic transforming avatar characteristics tool according to claim 16, wherein the avatar characteristic comprises at least one of visual, voice or motion attributes.

18. The automatic transforming avatar characteristics tool according to claim 17, wherein the visual, voice and motion attributes comprise appearance, language, posture and gesture.

19. The automatic transforming avatar characteristics tool according to claim 16, wherein the predetermined transformation criteria comprises location of the avatar in the virtual universe and characteristics of avatars that are in the general vicinity of the located avatar.

20. The automatic transforming avatar characteristics tool according to claim 16, further comprising an assessor component configured to assess the avatar characteristics associated with the location in the virtual universe that the avatar is located in.

21. The automatic transforming avatar characteristics tool according to claim 20, further comprising a virtual region information collector component configured to query the region in the virtual universe that the avatar is located for specified avatar characteristics that are associated with the location.

22. The automatic transforming avatar characteristics tool according to claim 20, further comprising a virtual region information collector component configured to ascertain a textual description associated with the location in the virtual universe for determining avatar characteristics therefrom.

23. The automatic transforming avatar characteristics tool according to claim 20, wherein the assessor component is configured to assess the characteristics of avatars that are in the general vicinity of the located avatar.

24. The automatic transforming avatar characteristics tool according to claim 23, wherein the assessor component is configured to perform a statistical analysis on the avatar characteristics associated with the avatars that are in the general vicinity of the located avatar.

25. The automatic transforming avatar characteristics tool according to claim 23, wherein the assessor component is configured to analyze metadata associated with the avatars and determine avatar characteristics of the avatars located in the general vicinity of the located avatar.

26. The automatic transforming avatar characteristics tool according to claim 16, further comprising a transformation transaction component configured to charge a transformation fee to the avatar for the automatic transformation of an avatar characteristic.

27. A computer-readable medium storing computer instructions, which when executed, enables a computer system to automatically transform an avatar characteristic of an avatar that is online in a virtual universe, the computer instructions comprising:
locating the avatar in the virtual universe; and
automatically transforming the avatar characteristic associated with the avatar according to predetermined transformation criteria.

28. The computer-readable medium according to claim 27, wherein the avatar characteristic comprises at least one of visual, voice or motion attributes.

29. The computer-readable medium according to claim 28, wherein the visual, voice and motion attributes comprise appearance, language, posture and gesture.

30. The computer-readable medium according to claim 27, wherein the predetermined transformation criteria comprises location of the avatar in the virtual universe and characteristics of avatars that are in the general vicinity of the located avatar.

31. The computer-readable medium according to claim 27, further comprising instructions for assessing the avatar characteristics associated with the location in the virtual universe that the avatar is located in.

32. The computer-readable medium according to claim 31, wherein the assessing of avatar characteristics comprises instructions for querying the location in the virtual universe that the avatar is located for specified avatar characteristics for entering the location.

33. The computer-readable medium according to claim 31, wherein the assessing of avatar characteristics comprises instructions for ascertaining a textual description associated with the location in the virtual universe and determining avatar characteristics from the textual description.

34. The computer-readable medium according to claim 27, further comprising instructions for assessing the characteristics of avatars that are in the general vicinity of the located avatar.

35. The computer-readable medium according to claim 34, wherein the assessing of avatar characteristics comprises instructions for performing a statistical analysis on the avatar characteristics associated with the avatars that are in the general vicinity of the located avatar.

36. The computer-readable medium according to claim 34, wherein the assessing of avatar characteristics comprises instructions for analyzing metadata associated with the avatars and determining avatar characteristics of the avatars located in the general vicinity of the located avatar.

37. The computer-readable medium according to claim 34, wherein the assessing of avatar characteristics comprises instructions for using artificial intelligence data processing techniques to determine avatar characteristics of the avatars located in the general vicinity of the located avatar.

38. The computer-readable medium according to claim 27, further comprising instructions for charging a transformation fee to the avatar for the automatic transformation of an avatar characteristic.

39. A method for deploying an avatar characteristics transformation tool for use in a computer system that automatically transforms an avatar characteristic of an avatar that is online in a virtual universe, comprising:
providing a computer infrastructure operable to:
locate the avatar in the virtual universe; and
automatically transform the avatar characteristic associated with the avatar according to predetermined transformation criteria.
